(19) United States
(12) Patent Application Publication
(10) Pub. No.: US 2020/0137056 A1
(43) Pub. Date: Apr. 30, 2020

(54) CLIENT DEVICE RE-AUTHENTICATION

(71) Applicant: Hewlett Packard Enterprise Development LP, Houston, TX (US)

(72) Inventors: Badrish Havaralu Rama Chandra Adiga, Bangalore (IN); Balaji Sankaran, Bangalore (IN); Bhupesh Bhargava, Bangalore (IN); Vinay Kumar Vishwakarma, Bangalore (IN)

(21) Appl. No.: 16/176,934

(22) Filed: Oct. 31, 2018

(51) Int. Cl. H04L 29/06; H04W 12/06; G06F 21/44

(52) U.S. Cl. CPC H04L 63/0892; H04L 63/0853; H04W 12/06; G06F 2221/2129; H04L 2209/80; G06F 2221/2139; G06F 21/44

(57) ABSTRACT

A system and method authenticating a client device transmitting a request to access a network that includes an authentication server to implement an authentication protocol for access to the network, and an authenticator to transmit identity credentials of the client device using the authentication protocol to the authentication server to perform authentication of the client device at the authentication server. The authenticator downloads credentials of the authenticated client device from the authentication server, determines, during a re-authentication period, whether the authentication server is available, and performs re-authentication of the client device using the downloaded credentials when the authentication server is determined not to be available.

### BACKGROUND

Point-to-point protocol (PPP) can be used for dial-up Internet access and is used by some internet service providers (ISPs) for a digital subscriber line (DSL) and cable modem authentication, in the form of point-to-point protocol (PPP) over Ethernet. PPP has evolved beyond its original use as a dial-up access method and includes an authentication mechanism. For example, for dial-up Internet access, a user name and password are used for authentication and PPP authentication is utilized to identify the user at the other end of the PPP line before granting the user access. In order to provide additional security, an additional authentication protocol known as Extensible Authentication protocol (EAP) can be included within the PPP protocol. EAP provides a generalized framework for several different authentication methods and enables everything from passwords to challenge-response tokens and public-key infrastructure certificates to all work smoothly.

### BRIEF DESCRIPTION OF THE DRAWINGS

FIG. 1 is a schematic diagram of an example computer network in accordance with the present disclosure.

FIG. 2 is a schematic diagram of an example authentication system in accordance with the present disclosure.

FIG. 3 is a flowchart of a method of performing authentication of a client device according to the present disclosure.

FIG. 4 illustrates an example of a message flow for performing authentication of a client device according to the present disclosure.

FIG. 5 is a flowchart of a method of performing authentication of a client device according to the present disclosure.

### DETAILED DESCRIPTION

In some authentication protocols, such as the authentication protocol described in the IEEE 802.1X standard, authenticated clients can be re-authenticated periodically. This can de-authenticate stale authenticated clients, thereby providing additional security to the network. However, during these periodic re-authentications, if the authentication server is unreachable for a short period of time, such as during instances of loss of connectivity between the authenticator and the authentication server, the re-authentication process may timeout, forcing valid authenticated clients to be prevented from accessing the network. Branch gateways are moving away from reliable multiprotocol label switching (MPLS) based connectivity to cheaper, less reliable digital subscriber line (DSL) based connectivity. Consequently, the uplink connectivity can vary widely, resulting in increased instances of loss of connectivity. Therefore, measures can be taken to ensure that a beneficial uplink for valid clients is utilized at any given instant to reduce the effects that loss of the re-authentication process may have on the user experience of a valid client.

Cached re-authentication and fallback authentication can be utilized to address situations when loss of connectivity between the authenticator and the authentication server occurs. Cached re-authentication addresses instances when loss of connectivity between the authenticator and the authentication server occurs by allowing the clients that have already been authenticated to retain their currently assigned credential attributes and providing uninterrupted service to those clients. As a result, any user credentials can be valid during the period of loss of connectivity even if they are different from those credentials used during the last successful authentication of the same session. Therefore, the disadvantage of cached re-authentication is that previously authenticated clients will be assumed to be valid clients without any re-authentication being performed, which in effect is the same as no re-authentication being performed during those periods of lost connectivity.

In fallback re-authentication an authentication is attempted using a local authenticator. The disadvantage of fallback re-authentication is that the credentials for the current clients are manually configured on the access switches of the local authenticator. As the number of access-switches and/or the number of client devices that can connect to any of the access-switches increases, the difficulty involved in the configuration and management of the local authenticator also increases and may reach a condition of being unmanageable.

In some examples of the present disclosure, client credentials are downloaded via a secure channel such as HTTPS, remote authentication dial-in user service (RADIUS) over IPsec, etc., to the authenticator and utilized during the re-authentication process for authenticating a prior valid authenticated client device whenever connection to the authentication server is interrupted and therefore not obtained. In particular, once the client is initially authenticated and is therefore considered a valid client, user credentials for the client can be downloaded securely to an authenticator from an authentication server via secure channels, such as HTTPS, RADIUS over IPsec, etc. These cached credentials in the authenticator can then be used for periodic re-authentication of the client when the authentication server becomes unavailable, such as when connectivity to the authentication server is lost, for example, and therefore connection to the authentication server cannot be obtained for re-authentication by a valid authenticated client.

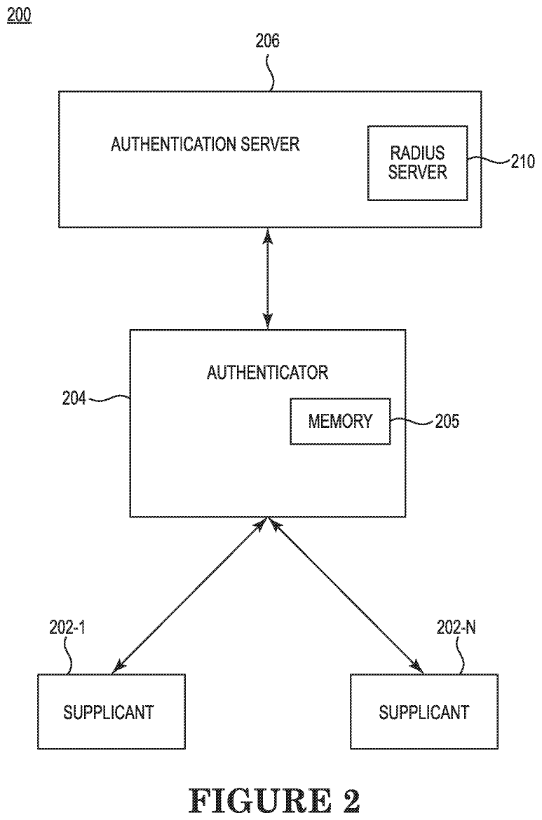

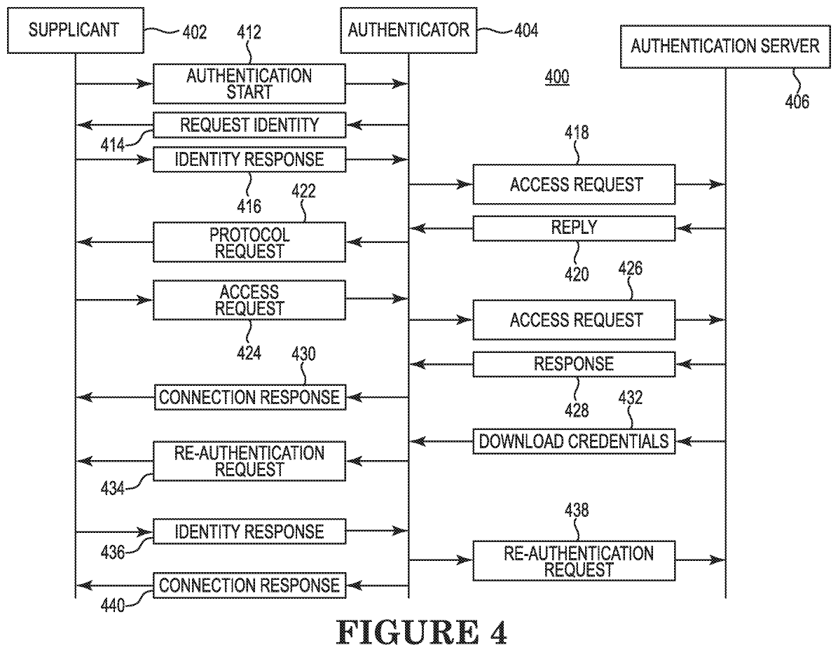

The figures herein follow a numbering convention in which the first digit corresponds to the drawing figure number and the remaining digits identify an element or component in the drawing. For example, reference numeral 206 refers to element “206” in FIG. 2 and an analogous element may be identified by reference numeral 406 in FIG. 4. Analogous elements within a Figure may be referenced with a hyphen and extra numeral or letter. See, for example, elements 202-1, and 202-N in FIG. 2. Such analogous elements may be generally referenced without the hyphen and extra numeral or letter. For example, elements 202-1 and 202-N may be collectively referenced as 202. Elements shown in the various figures herein can be added, exchanged, and/or eliminated so as to provide a number of additional examples of the disclosure. In addition, the proportion and the relative scale of the elements provided in the figures are intended to illustrate the examples of the disclosure and should not be taken in a limiting sense.

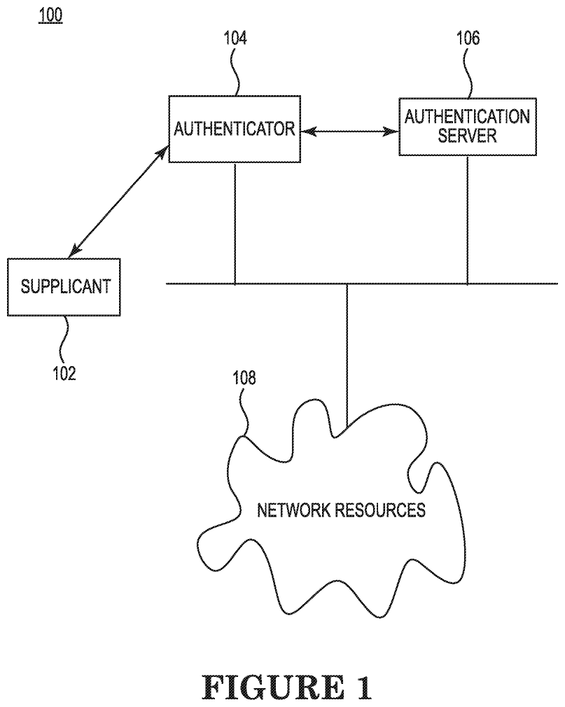

FIG. 1 is a schematic diagram of an example computer network 100 in accordance with the present disclosure. A computer network 100 may be a local area network (LAN). The LAN can be a computer network that links or interconnects devices such as computers within a limited area such as a residence, school, laboratory, university campus or office building. By contrast, a wide area network covers a larger geographic distance in addition to also generally involving lease telecommunication circuits. As illustrated in FIG. 1, the computer network 100, according to an example of the present disclosure, can include a supplicant 102, an authenticator 104 and an authentication server 106.

The supplicant 102 can be a user or client device, such as a laptop computer, that is requesting to be authenticated and connected to LAN resources 108. The term “supplicant” is also used interchangeably to refer to instructions running on the client that provides credentials to the authenticator 104 and therefore may also be referred to as a client.

The authenticator 104 is a network device, such as an Ethernet switch or wireless access point, that provides a way to ascertain for a computer system that the client device is the client device it claims to be rather than being a rouge client device without permission to connect to the LAN resources 108, whereby this ascertaining is commonly known as “authentication”. The authenticator 104 can be a program, application, hardware, firmware, etc., typically performing somewhere on the computer network 100 to perform authentication. For example, the authenticator 104 can operate according to the IEEE 802.1X standard for which the authenticator 104 is an entity at one end of a point-to-point LAN segment that facilitates authentication of a client device connected to the other end of the point-to-point LAN segment. The authenticator 104 can be a network switch or a wireless access point that serves as a point of connection for computer devices joining the network 100.

The authentication server 106 can be a type of network server that validates and authenticates remote users or nodes connecting to an application or service. The authentication server 106 stores the user names and passwords that identify the client devices, along with user permissions to access an application or service. The authentication server 106 can be a host running instructions supporting authentication protocols, such as the remote authentication dial-in user service (RADIUS) protocol and the extensible authentication protocol (EAP). The RADIUS protocol is a networking protocol that provides centralized authentication, authorization and accounting (AAA) management for users that connect and use a network service. As a result of the broad support and the universal nature of the RADIUS protocol, RADIUS is often utilized by internet service providers (ISPs) and enterprises to manage access to the internet or internal networks, wireless networks, and integrated email services. These networks may incorporate modems, a digital subscriber line (DSL), wireless access points (WAPs), or more generally access points (SPs) for allowing a device to connect to a network, virtual private networks (VPNs), network ports, web servers, etc. RADIUS is a client/server protocol that runs in the application layer, which is an abstraction layer that specifies the shared communication protocols and interface methods used by hosts (i.e., a computer or other device that establishes a connection to a network) in a communication network. The EAP is an authentication framework used in wireless networks and point-to-point connections for providing transport and usage of keying material and parameters.

The authenticator 104 functions as a security guard for a protected network, such as network 108. The supplicant 102 (i.e., client device) may not be allowed to access through the authenticator 104 to a protected side of the network 100 until the identity of the supplicant 102 has been validated and authorized. In the 802.1X port-based authentication, the supplicant 102 provides credentials, such as a username and password or a digital certificate, for example, to the authenticator 104. The authenticator 104 can forward the credentials to the authentication server 106 for verification. In this way, the authenticator 104 acts as a pass-through device that facilitates the authentication of the supplicant 102 by the authentication server 106. If the authentication server 106 determines the credentials are valid, the supplicant 102 can be allowed to access resources located on the protected side of the network 100, i.e., the LAN resources 108. On the other hand, if the authentication server 106 determines the credentials are not valid, the authentication request of the supplicant 102 can be denied.

FIG. 2 is a schematic diagram of an example authentication system 200 in accordance with the present disclosure. The authentication system 200 can include multiple client devices or supplicants 202-1, . . . , 202-N (hereinafter referred to collectively as supplicant 202), an authenticator 204 having a memory 205, an authentication server 206, and a RADIUS server 210 included within the authentication server 206. The supplicant 202 is a user or client device, such as a laptop computer, that is requesting to be authenticated and connected to LAN resources. The term “supplicant” is also used interchangeably to refer to instructions, hardware, firmware, etc., running on the client that provides credentials to the authenticator 204.

The authenticator 204 can be a network device with memory 205, such as an Ethernet switch or wireless access point network, that authenticates the supplicant 202 when the supplicant 202 is requesting network access. The authenticator 204 can be a program, application, etc., typically running somewhere on the authentication system 200 performs authentication. For example, the authenticator 204 can operate according to the IEEE 802.1X standard and can be a network switch or a wireless access point that serves as a point of connection for the supplicant 202 requesting connection to authentication server 206 via the authenticator 204. The authentication server 206 can be a host running instructions supporting authentication protocols, such as the protocol associated with the RADIUS protocol of RADIUS server 210.

The memory 205 can be any type of storage medium that can be accessed by the authenticator 204 to perform various examples of the present disclosure. For example, the memory 205 can be a non-transitory computer readable medium having computer readable instructions (e.g., computer program instructions) stored thereon that are executable by the authenticator 204 as described herein. The memory 205 can also be removable (e.g., portable) memory, or non-removable (e.g., internal) memory. For example, the memory 205 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical disk storage, and/or a magnetic medium such as magnetic cassettes, tapes, or disks, among other types of memory. Further, although the memory 205 is illustrated as being located in the authenticator 204, examples of the present disclosure are not so limited. For example, the memory 205 can also be located internal to another computing resource (e.g., enabling computer readable instructions to be downloaded over the Internet or another wired or wireless connection).

In order for the supplicant 202 to gain access to the network, an access request is transmitted from the supplicant 202 to the authenticator 204 via a link-layer protocol, such as the point-to-point protocol (PPP) in the case of a dial-up or digital subscriber line (DSL) provider, or in an HTTPS secure web form. The authenticator 204 can receive the request and transmit a RADIUS access request to the RADIUS server 210 positioned within the authentication server 206 using a RADIUS protocol. Once the supplicant 202 is authenticated, the authenticator 204 can download the credentials associated with the valid authenticated supplicant 202 from the authentication server 206 via a secure channel so that the credentials may be subsequently utilized for periodic re-authentication of the supplicant 202 when the RADIUS server 210 subsequently becomes unavailable.

In this way, the system 200 can include the authentication server 206 to implement an authentication protocol for validating access to the network, along with the authenticator 204 to transmit identity credentials of the client device 202 to the authentication server 204. As a result, authentication of the client device 202 can be performed at the authentication server 206 using the authentication protocol, as described below. The authenticator 204 downloads credentials of the authenticated client device 202 from the authentication server 206 via a secure channel, such as HTTPS, Radius over IPsec, etc., and determines, during a re-authentication period, whether the authentication server 206 is available. If the authentication server 206 is determined to be unavailable, the authenticator 204 performs re-authentication of the client device 202 using the downloaded credentials, as described below in detail.

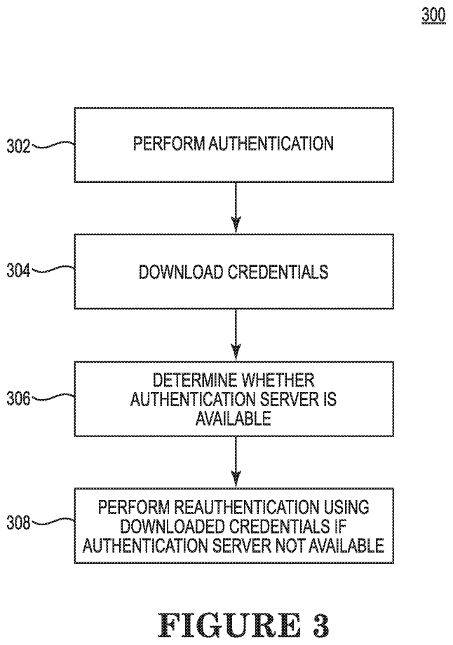

FIG. 3 is a flowchart of a method 300 of performing authentication of a client device according to an example of the present disclosure. At 302, authentication of a supplicant or client device is performed in response to a message flow between the client device, an authenticator, and an authentication server, as described below in detail in reference to FIG. 4. At 304, once the client device is authenticated and is therefore considered a valid client device, the authenticator downloads user credentials associated with the valid client device. At 306, during subsequent re-authentication of the client device, the authenticator determines whether the authentication server is available. At 308 the authenticator performs the re-authentication of the client device using the downloaded user credentials associated with the valid client device if the authentication server is determined to be unavailable. On the other hand, if the authentication server is determined to be available during the re-authentication of the client device, the authenticator performs the re-authentication using the message flow between the client device, the authenticator, and the authentication server that was used during the initial authentication of the client device at 302, described below.

FIG. 4 illustrates an example of a message flow 400 for performing authentication of a client device according to an example of the present disclosure. In certain authentication protocols, such as the authentication protocol described in the IEEE 802.1X standard, authenticated clients can be periodically re-authenticated. This can result in de-authentication of stale authenticated clients, i.e., valid clients that have not been active for an extended period of time, thereby providing additional security to the network. However, during these periodic re-authentications, if the authentication server cannot be reached for a short period of time, such as during instances of loss of connectivity between the authenticator and the authentication server, the re-authentication process may timeout, forcing valid authenticated clients to become no longer authenticated and therefore de-activated from the network.

In order to reduce such instances where valid authenticated clients are unable to be authenticated during re-authentication due to loss of connectivity between the authenticator 404 and the authentication server 406 during authentication of a client device or supplicant 402, the message flow 400 of FIG. 4 may be utilized. In the example message flow 400, the supplicant 402 and the authenticator 404 can transmit messages using a given authentication protocol, such as the extensible authentication protocol (EAP), which is also known as EAP over LAN (EAPOL), for example. The supplicant 402 can initiate or restart authentication by transmitting an authentication start request 412 to the authenticator 404. The authenticator 404 receives the authentication start request 412 and transmits an identity request 414 to the supplicant 402. In another example, the authenticator 404 can periodically transmit the identity request 414 to a special Layer 2 address on a local network segment without receiving the authentication start request 412. In either example, upon receipt of the identity request 414, the supplicant 402 transmits an identity response 416 containing an identifier for the supplicant 402, such as a user ID for example, to the authenticator 404.

When the authenticator 404 receives the identity response 416, the authenticator 404 transmits the identity response 416 to the authentication server 406 using an access request protocol, such as a RADIUS access-request packet, for example, 418. Upon receipt of the access request 418, the authentication server 406 transmits a reply 420 to the authenticator 404 specifying the protocol method to be utilized by the supplicant 402. For example, the reply 420 can be an EAP request specifying the type of EAP based authentication the authentication server 406 would like the supplicant 402 to perform. The authenticator 404 then encapsulates a protocol request 422 in the specified protocol and transmits the request to the supplicant 402.

Upon receipt of the protocol request 422, the supplicant 402 can begin using the specified protocol method of the reply 420 or may transmit a negative acknowledgement (NAK) to the authentication server 406 via the authenticator 404 responding with protocol methods the supplicant 402 is willing to perform. Once the authentication server 406 and the supplicant 402 agree on the protocol method, the supplicant 402 transmits an access request 424 to the authenticator 404. The authenticator 404 translates the request 424 to conform to the given access protocol utilized between the authenticator 404 and the authentication server 406, such as RADIUS for example, and transmits the resulting translated request 426 to the authentication server 406. The authentication server 406 then determines whether access should be granted to the supplement 402 based on the received access request 426 and transmits a corresponding response 428 to the supplicant 402 via the authenticator 404, again using the access request protocol, such as a RADIUS access-request packet, for example, containing either a success message or a failure message.

Access requests 424 can be transmitted from the supplicant 402 to the authentication server 406 until authentication server 406 determines the response 428 from the authentication server 406 is a success message. If the response 428 is a success message, the authenticator 404 transmits a connection response 430 to the supplicant 402 containing a success message and sets the port to the “authorized” state and normal traffic is allowed between the supplicant 402 and the authentication server 406, enabling the supplicant 402 to access the desired network. On the other hand, if the response 428 is a failure message, the authenticator 404 sets the port to the “unauthorized” state and traffic is not allowed between the supplicant 402 and the authentication server 406. When the supplicant 402 logs off, the supplicant transmits a logoff message (not shown) to the authenticator 404, and the authenticator 404 then sets the port to the “unauthorized” state and traffic is not allowed between the supplicant 402 and the authentication server 406.

After transmitting the connection response 430 containing a success message, the authenticator 404 downloads and stores the credentials 432 for the supplicant 402 from the authentication server 406 in a secure channel and the credentials can be cached. After the supplicant 402 has been authenticated for a predetermined period of time, such as 60 minutes for example, the authenticator 404 transmits a re-authentication request 434 to the supplicant 402 requesting identity of the supplicant 406 for re-authentication. Upon receipt of the re-authentication request 434, the supplicant 402 transmits an identity response 436 containing an identifier for the supplicant 402, such as a user ID for example, to the authenticator 404.

When the authenticator 404 receives the identity response 436, the authenticator 404 attempts to transmit a re-authentication request 438 to the authentication server 406 using the access request protocol. If a response (not illustrated) to the transmitted re-authentication request 438 is not received from the authentication server 406, the authenticator 404 determines that the authentication server 406 is not available. Therefore, the authenticator 404 makes the determination as to whether or not re-authentication should be granted to the supplement 402 based on the received identity response 436 and the saved downloaded credentials 432. The authenticator 404 transmits a corresponding connection response 440 to the supplicant 402 containing either a success message or a failure message. If the authenticator 404 determines re-authentication should be granted and therefore the connection response 440 is a success message, the authenticator 404 allows the port to continue to be set in the “authorized” state and normal traffic is continued to be allowed between the supplicant 402, the authenticator 404 and the authentication server 406, enabling the supplicant 402 to continue to access the network. On the other hand, if the authenticator 404 determines re-authentication should not be granted and therefore the connection response 440 is a failure message, the authenticator 404 sets the port to the “unauthorized” state and traffic is no longer allowed between the supplicant 402, the authenticator 404 and the authentication server 406.

If a response to the re-authentication request 438 transmitted by the authenticator 404 is received from the authentication server 406, the authenticator 404 determines that the authentication server 406 is available to perform re-authentication and therefore the authentication flow described at 424-430 is repeated between the supplicant 402, authenticator 404 and authentication server 406 in order to re-authenticate the supplicant 402.

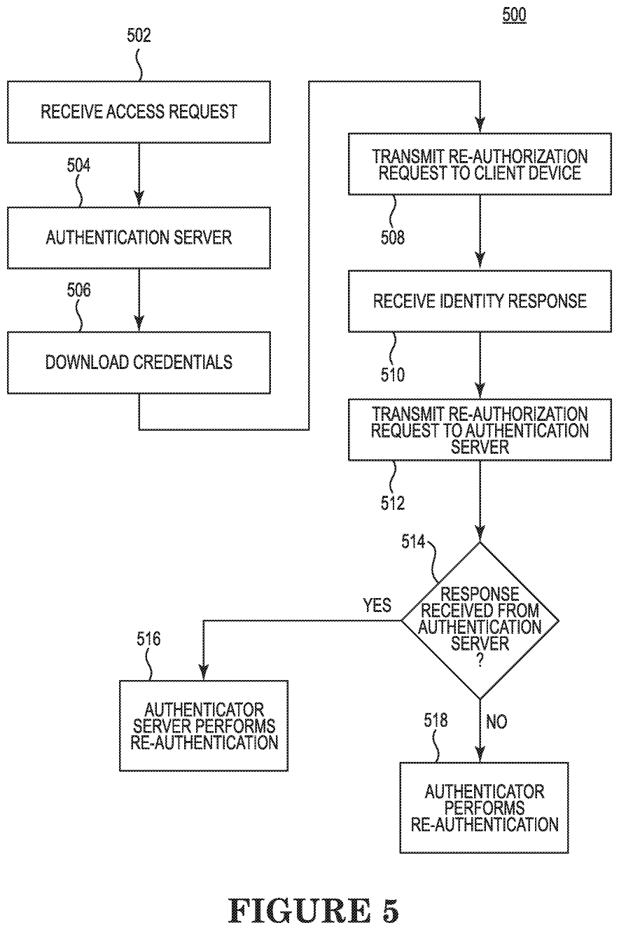

FIG. 5 is a flowchart 500 of an example method of performing authentication of a client device 500 according to the present disclosure. At 502, an authenticator receives an access request transmitted using an access request protocol, such EAP for example. The access request contains an identifier identifying a client device, such as a user ID, for example. At 504, the authenticator translates the access request to an access request protocol, such as RADIUS for example, and transmits the translated request to the authentication server. At 506, the authenticator downloads and stores the credentials for the client device from the authentication server. After the client device has been authenticated for a predetermined period of time, the authenticator transmits a re-authentication request to the client device, at 508.

When the authenticator receives the identity response at 510, the authenticator attempts to transmits a re-authentication request to the authentication server, at 512, using the access request protocol. At 514, the authenticator determines whether a response to the transmitted re-authentication request is received from the authentication server. At 516, if a response to the transmitted re-authentication request is received from the authentication server (“YES” from 514), the authenticator determines that the authentication server is available and the authentication server performs the re-authentication of the client device based on receiving another identity response from the client device via the authenticator. At 518, if a response to the transmitted re-authentication request is not received from the authentication server (“NO” from 514), the authenticator determines that the authentication server is not available and therefore the authenticator performs the re-authentication of the client device based on an identity response received from the client device and the downloaded credentials.

For example, the authenticator makes the determination as to whether or not re-authentication should be granted to the client device based on the received identity response and the saved downloaded credentials. The authenticator transmits a corresponding connection response to the client device containing either a success message or a failure message. If the authenticator determines re-authentication should be granted and therefore the connection response is a success message, the authenticator allows the port to continue to be set in the “authorized” state and normal traffic is continued to be allowed between the client device, the authenticator and the authentication server, enabling the client device to continue to access the desired network. On the other hand, if the authenticator determines, based on the received identity response and the saved downloaded credentials, re-authentication should not be granted and therefore the connection response is a failure message, the authenticator sets the port to the “unauthorized” state and traffic is no longer allowed between the client device, the authenticator and the authentication server.

In this way, an example device according to the present disclosure can include an authenticator to transmit identity credentials of a client device requesting to access a network to perform authentication of the client device, and a memory positioned within the authenticator. The authenticator can be configured to download credentials associated with the client device within the memory, transmit a re-authentication request for re-authenticating the client device, determine whether a reply is received in response to the re-authentication request, and perform the re-authentication using the downloaded credentials in response to the reply not being received.

In the foregoing detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

What is claimed is:

1. A method, comprising
performing authentication of a client device requesting to access a network;
downloading credentials of the authenticated client device from an authentication server to an authenticator;
determining, during a re-authentication period, whether the authentication server is available; and
performing re-authentication during the re-authentication period using the downloaded credentials in response to the authentication server being unavailable.

2. The method of claim 1, wherein authentication is performed according to the IEEE 802.1X standard.

3. The method of claim 1, further comprising:
transmitting an access request from the client device to the authenticator; and
transmitting a corresponding access request using an access request protocol from the authenticator to the authentication server in response to the access request from the client, wherein the access request protocol comprises a remote authentication dial-in user service (RADIUS) protocol.

4. The method of claim 1, further comprising transmitting a connection response from the authentication server to the authenticator, wherein credentials of the authenticated client device are downloaded from the authentication server to the authenticator in response to the connection response.

5. The method of claim 1, further comprising:
transmitting a re-authentication request for the client device from the authenticator to the authentication server;
determining whether a reply is received from the authentication server in response to the re-authentication request; and
performing the re-authentication using the downloaded credentials in response to the reply not being received.

6. The method of claim 5, further comprising performing the re-authorization at the authentication server in response to the reply being received.

7. The method of claim 1, further comprising:
transmitting a re-authentication request for the client device from the authenticator to the client device;
transmitting an identity response that includes the credentials from the client device to the authenticator in response to the re-authentication request;
translating, at the authenticator, the re-authentication request to conform to an access protocol utilized between the authenticator and the authentication server; and
transmitting the translated re-authentication request and the credentials from the authenticator to the authentication server, wherein the access request protocol comprises a remote authentication dial-in user service (RADIUS) protocol.

8. The method of claim 7, further comprising;
determining whether a reply to the translated re-authentication request is received from the authentication server in response to the translated re-authentication request; and
performing the re-authentication using the downloaded credentials in response to the reply not being received.

9. The method of claim 7, comprising performing the re-authentication at the authentication server in response to the reply being received.

10. A system for authenticating a client device transmitting a request to access a network, comprising:
an authentication server to implement an authentication protocol for access to the network; and
an authenticator to transmit identity credentials of the client device to the authentication server to perform authentication of the client device at the authentication server using the authentication protocol,
wherein the authenticator is to:
download credentials of the authenticated client device from the authentication server;
determine, during a re-authentication period, whether the authentication server is available; and
perform re-authentication of the client device using the downloaded credentials in response to the authentication server being determined to not be available.

11. The system of claim 10, wherein the authenticator is to:
transmit a re-authentication request for the client device to the authentication server;
determine whether a reply is received from the authentication server in response to the re-authentication request; and
perform the re-authentication using the downloaded credentials in response to the reply not being received.

12. The system of claim 11, wherein the re-authentication is performed by the authentication server in response to the reply being received.

13. The method of claim 1, wherein the authenticator is to:
translates the re-authentication request to conform to an access protocol utilized between the authenticator and the authentication server; and
transmits the translated re-authentication request to the authentication server,
wherein the access request protocol comprises a remote authentication dial-in user service (RADIUS) protocol.

14. The system of claim 13, wherein the authenticator is to:
determine whether a reply to the translated re-authentication request is received from the authentication server in response to the translated re-authentication request; and
perform the re-authentication using the downloaded credentials in response to the reply not being received.

15. The system of claim 14, wherein the re-authorization is performed by the authentication server in response to the reply being received.

16. A device, comprising:
an authenticator to transmit identity credentials of a client device requesting to access a network to perform authentication of the client device; and
a memory positioned within the authenticator;
wherein the authenticator is to:
download credentials associated with the client device within the memory;
transmit a re-authentication request for re-authenticating the client device;
determine whether a reply is received in response to the re-authentication request; and
perform the re-authentication using the downloaded credentials

17. The device of claim 16, wherein the authenticator performs the re-authentication using the downloaded credentials in response to the reply not being received.

18. The device of claim 16, wherein the authenticator is to:
translate the re-authentication request to conform to an access protocol utilized between the authenticator and an authentication server; and
transmit the translated re-authentication request to the authentication server;
wherein the access request protocol comprises a remote authentication dial-in user service (RADIUS) protocol.

19. The device of claim 18, wherein the authenticator is to:
determine whether a reply to the translated re-authentication request is received in response to the translated re-authentication request; and
perform the re-authentication using the downloaded credentials in response to the reply not being received.

20. The device of claim 19, wherein the re-authorization is performed by the authentication server in response to the reply being received.
